(19) United States
(12) Patent Application Publication
(10) Pub. No.: US 2003/0233361 A1
(43) Pub. Date: Dec. 18, 2003

(54) Resumption of user authentication and restoration of interrupted virtual sessions in a stateless network

(76) Inventor: C. Conrad Cady, Castro Valley, CA (US)

Correspondence Address: GLENN PATENT GROUP, 3475 EDISON WAY, SUITE L, MENLO PARK, CA, 94025, US

(21) Appl. No.: 10/172,178

(22) Filed: Jun. 13, 2002

(51) Int. Cl. G06F 17/30

(52) U.S. Cl. 707/10

(57) ABSTRACT

This invention is embodied in an interactive message communication system in a stateless network such as the Internet, providing for resumption of user authentication and restoration of interrupted virtual sessions without loss of data or disruption of workflow. When a user enters the application from any source, he starts a new session by a successful login. The login page includes hidden contextual information describing the initial user request. The hidden contextual information, once submitted together with the proper user ID and password is used to resume the user request and allow the Web server to respond. While in the circumstances where a session is expired or timed-out, when the user completes his message and submits his request, the Web server sends the hidden contextual information included in the request, along with a login page, back to the browser. The user is required to reenter his login information. When he logs in again, all contextual information included in his original request is resubmitted with the login information. An authenticator in the Web server then verifies the login information against the server's database. If the login information is correct, the user is authenticated, and therefore his request is proceeded and the virtual session is restored without loss of data. If the login information is incorrect, the authentication fails, and the login page is returned to the browser. This cycle may be repeated as many times as the user submits incorrect login information. Alternatively, it may be repeated until a predetermined number of attempts is reached, at which point the server refuses to respond further.

### BACKGROUND OF THE INVENTION

1. Technical Field

The invention relates generally to systems and processes for interactive message communication via stateless networks such as the Internet or other public or private networks. More particularly, the invention relates to a system and a process providing for resumption of user authentication and restoration of interrupted virtual sessions without loss of data or disruption of workflow.

2. Description of the Prior Art

With the advent of interactive network communications which have been broadly used in private and public communications, it is becoming necessary to find ways to improve efficiency and effectiveness of such communications by employing new processes of sessions management. Under current systems and methods for message communication via stateless networks such as the Internet, if a user's message is not completed and sent within a predetermined duration of a single, continuous session, his workflow will be interrupted and the data he created in the session will be lost. This often happens when a server crashes or, more likely, the server “times out” a session when there has been no activity within a selected time interval. This is especially true where a user, who composed a message and was to send it, is unaware that his session has been “timed out”. Even if in the circumstances where a user is aware or suspects that his session has been terminated thus he can take his own effort such as making a copy to preserve some or all the data on the last screen before attempting to send it, there is currently no way to preserve or record the exact flow of Web pages and data that preceded the last screen. In either case, because a session cannot be effectively resumed or continued once it was interrupted, time has been wasted, efficiency lost, workflow interrupted, resources wasted and distraction, annoyance and stress increased.

In all public or private network communications, especially in military and health care services, sometimes it is essential for a user to compose and send out his message in a single, uninterrupted session. If a session is interrupted, for instance, when a medical doctor is called away or takes a phone call, a Web server may “time out” his session before he returns to his monitor. When he returns to his monitor, he probably assumes that his session is still active and attempts to complete his message. When he completes his message and attempts to send out his message by clicking “Send” button, because of the Web server's “timing out”, he will be denied access to the server and the information he already input will be lost, and thus he has to log in again in order to initiate a new session. This will cause serious problems if the lost information is crucial and irretrievable.

As presently configured, the Internet, like most LANs, WANs or Intranets, is a stateless network. Unlike an analog telephone network where an actual or virtual circuit is maintained between two telephone terminals, on the Internet, there is no specific electronic circuit is maintained between a Web client and a Web server during a session. What occurs during an Internet session where two correspondents sends and receives a sequence of letters through email is in many ways analogous to “snail mail” correspondence. When a user goes to a Website, a packetized request is sent from the user's Web client device via the Internet to a Web server, and the Web server sends back a packetized “Web page”. Both the Web client and the Web server are coupled to the Internet, but they are not directly connected to each other.

At an unsecured, informational Website where information flows only from a Web server to a user, the Web server usually does not keep memory of the user's request. For instance, if the Web server receives a second request from the same user, the Web server does not identify the user and just treat this user as a new user. However, at an interactive Website where information flows in both directions, it is necessary for the Web server to create and maintain a “session” for a certain length of time. During the session, the Web server recognizes the user when it receives additional requests from the same user, and responds to information submitted by the user. For instance, someone shopping online at an e-commerce Website may have a “shopping cart” to which he is adding items, and the Web server continues to recognize him during the session. However, when the session is “timed out”, the Web server will no longer recognize him and will no longer respond to his subsequent requests unless he starts a new session.

In a secure Website, in order to recognize and distinguish authorized users from unauthorized users, a session is usually maintained by a combination of “cookies” and a Web server memory allocation. According to this method, when a user initiates a session by sending a message to a Web server, the Web server allocates a small amount of its memory identifying the user and creates a “cookie” specifying the location of the identified information in its memory. The Web server then sends the “cookie” back to the user as a hidden property or attribute along with the Web page responsive to the user's request. The “cookie” may be created when the Web server responds to a first request from a user, typically by sending the Website's homepage, or may be created at some other selected point, such as when a user first clicks on “Add to Shopping Cart.” Subsequently, when the user sends a further request, the Web server will recognize the user by reading the “cookie” which is included with the request.

The more sessions a Web server maintains simultaneously, the larger memory capacity it requires. To maintain an unlimited number of sessions indefinitely, even if the server merely maintains “cookies” instead of an entire record of each session including the information exchanged between the Web client and the Web server, an infinitely large memory capacity must be built. However, an infinitely large memory capacity is technically impossible. That is why a Web server is configured in such a way that after a predetermined period of time has elapsed since a session started by a request from a particular user, the Web server “times out” the user and terminates the session. Once this occurs, the user must re-log in and initiate a new session if he wants to contact that Website. When he tries to re-log in, he will be directed to a login page and will be required to submit a “user name” and a password to the Web server; the Web server will compares the user's login information against its database. If the user's input matches the ID information stored in the database, his login is successful and he simply goes through a new session, which is nothing related to the previous session. During this re-login process, the user's workflow is interrupted and the contextual information is lost.

In summary, in a stateless network such as the Internet, whenever a user is interrupted, whether voluntarily or due to automatic “timing out” of a session by a Web server, there is no way to avoid interruption of work and online application flow.

What is desired is to develop a mechanism for the login process to enable a user to resume an interrupted session by entering his correct login information.

### SUMMARY OF THE INVENTION

In accordance with its basic nature, the present invention aims to overcome the limitation of prior art by a login scheme that provides for resumption of user authentication and restoration of interrupted virtual session in a stateless Web application. According to the invention, when a user enters the application from any source, he starts a new session by a successful login. The login page includes hidden contextual information describing the initial user request. The hidden contextual information, once submitted together with the proper user ID and password, is used to restore the user request and allow the Web server to respond. While in the circumstances where a session is expired or timed-out, when a user completes his message and submits his request by clicking “Send” button, the Web server sends the hidden contextual information included in the request, along with a login page, back to the browser. The user is required to reenter his login information and re-log in. When he clicks the “Login” button, all contextual information included in his original request is resubmitted with the login information. An authenticator in the Web server then verifies the login information against the server's database. If the login information is correct, the user is authenticated, and therefore his request is proceeded, the Web content is returned, and the virtual session is restored without loss of data. If the login information is incorrect, however, the authentication fails, and the login page is returned to the browser. This cycle may be repeated as many times as the user submits incorrect login information. Alternatively, it may be repeated until a predetermined number of attempts is reached, at which point the server refuses to respond further.

### BRIEF DESCRIPTION OF THE DRAWINGS

FIG. 1 is a block diagram showing a system embodiment of the invention for implementation on the Internet, in which a medical service provider and a patient communicate through a medical relationship management application service provider via the Internet;

FIG. 2 is a data flow diagram illustrating a process according to the invention, comprising various steps that collectively enable the functionality of the invention;

FIG. 3 shows a screen capture of a Web page with a Web application form filled in by a patient, immediately prior to pushing the “Send” button;

FIG. 4 shows a screen capture of a confirmation message seen by a patient after successfully sending the message screen shown in FIG. 3; and

FIG. 5 shows a screen capture of the login page seen by a patient if the patient user has attempted to send the message screen shown in FIG. 3 but authentication has failed because the session timed out or otherwise terminated before the patient was able to send the message screen shown in FIG. 3.

### DETAILED DESCRIPTION OF THE INVENTION

The invention generally applies to all types of messaging communications via stateless networks such as the Internet, and all types of computer network architectures including server-client and peer-to-peer, where it is desirable to provide for resumption of user authentication and restoration of interrupted virtual sessions without loss of data or disruption of workflow.

In the preferred embodiment, the invention is a process and system supporting, facilitating and leveraging interactive communications between patients and medical service providers including, but not limited to, physicians, physician extenders such as nurses, technicians, and office or hospital staff, pharmacies, and medical device suppliers, and communications between said medical service providers.

In the following detailed description of the invention, some specific details are set forth to provide a thorough understanding of the presently preferred embodiment of the invention. However, it will be apparent to those skilled in the art that the invention may be practiced in embodiments that do not use the specific details set forth herein. Well known methods, procedures, components, and circuitry have not been described in detail.

In the following discussion, in references to the drawings like numerals refer to like parts throughout the several views.

System Embodiment of the Invention

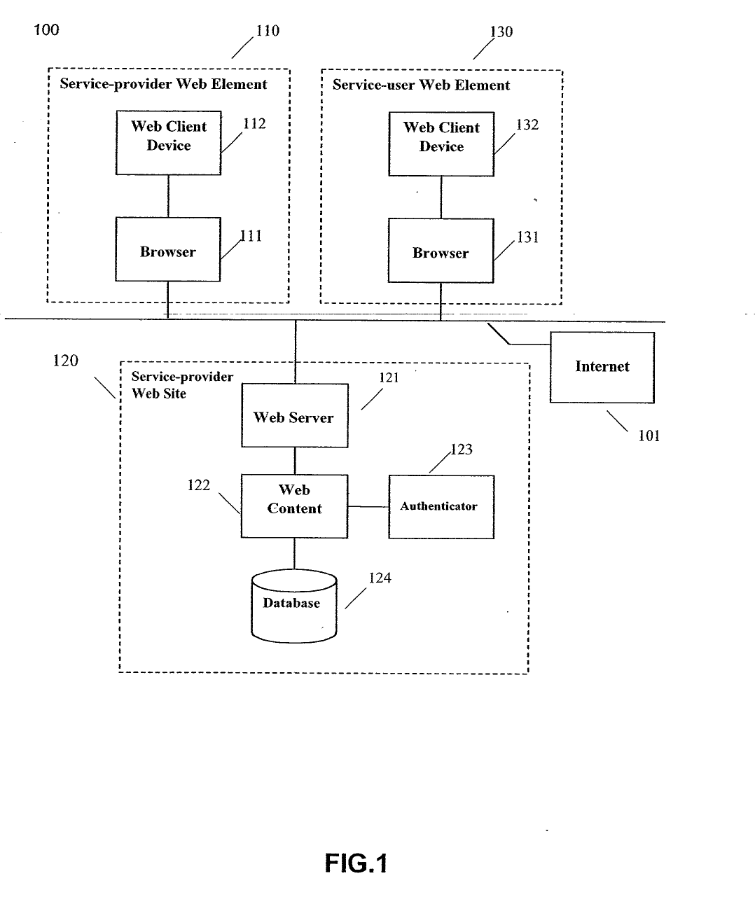

FIG. 1 is a block diagram that illustrates a system embodiment of the invention 100, comprising a medical service provider Web client 110, a medical relationship management application (MRMA) service provider Website 120, and a patient Web client 130, all coupled by the Internet 101.

The medical service provider Web client 110 includes a browser 111 installed on a medical service provider Web client device 112. The medical service provider may be a doctor or a doctor extender such as registered nurse, medical assistant or technician, pharmacy, medical device manufacturer or retailer, or any other person or entity which provides services to or on behalf of medical professionals. The browser 111 may be any suitable browser software such as Netscape Navigator by Netscape Communications, Inc., Internet Explorer by Microsoft Corporation, or the like.

The MRMA service provider Website 120 includes a Web server 121, a Web content 122, and a database 124. The Web content 122 is coupled to an authenticator 123. The Web content entails all the services and data that the MRMA provides to its clients such as doctors and patients.

The patient Web client 130 includes a browser 131 installed on a patient Web client device 132. The browser 131, like the browser 111, may be any suitable browser software such as Netscape Navigator by Netscape Communications, Inc., Internet Explorer by Microsoft Corporation, or the like.

For illustration purpose, only one patient and one medical service provider are shown in FIG. 1. In practice, the number of patients and medical service providers varies depending upon practical considerations such as server capacity and speed, memory capacity, and the Internet channel bandwidth.

The medical service provider Web client device 112 and the patient Web client device 132 are preferably personal computers, but alternatively could be any Web-enabled device capable of sending and receiving information via the Internet 101, such as a personal digital assistant and the like.

The Process According to the Invention

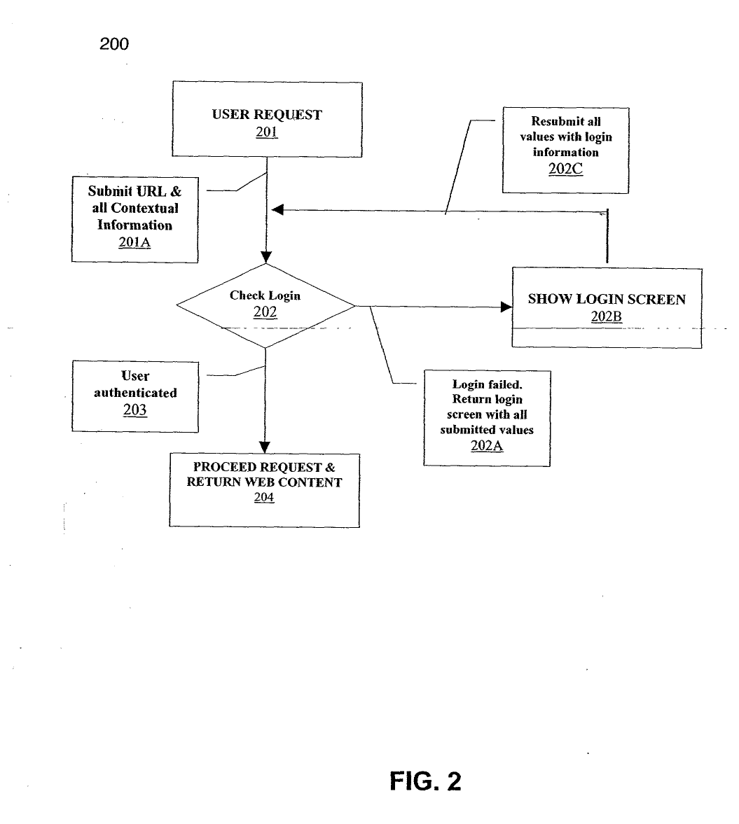

FIG. 2 is a flow diagram which illustrates a process embodiment 200 of the invention. The process provides for continuation of a communication session in a stateless network, comprising the following steps:

Step 201: A user such as a service provider 110 or a patient 130, who has already logged into an MRMA service provider's Website 120 via a browser 111 running on Web client device 112, prepares a service request for a resource and is ready to click the Send button.

Step 201A: The user's service request, together with all contextual information, is sent to an MRMA service provider Website 120 via the Internet. The contextual information herein refers to all relevant information that identifies where the user is and where he is going to in a communication session.

Step 202: The MRMA service provider Web server 121 receives the user service request and calls an authenticator 123 to verify if the user has ever logged into the Website 120 within a predetermined period of time prior to receipt of the service request. The authenticator 123 first attempts to check whether there is a session alive for the user. If there is one, the authenticator retrieves the login information and verifies it against the database 124 (see Step 203). If there is no session alive for the user, the authenticator checks whether there is a correct login information included in the request. If yes, the authenticator retrieves the login information and verifies it against the database 124 (see Step 203). Otherwise, the authentication fails (see Step 202A).

Step 202A: If the authenticator fails to verify the login information for any reason—for examples, the user had never logged in the Website, or the user did log in previously but a predetermined period of time elapsed or the session was interrupted, the MRMA Web server 121 sends a login screen, along with the contextual information which was associated with the original request in the interrupted or terminated session, to the users' Web client device 112. The contextual information herein is formatted in such a way that it is not displayed on the user's browser 111 running on Web client device 112.

Step 202B: The user's Web client device 112 receives the login screen and displays it to the user. Here, as described above, the contextual information is not shown on the user's browser 111 because it was formatted hidden in HTML.

Step 202C: The user enters required login information, i.e. Login ID and Password. The service request contains the original contextual information, which are hidden in the login page in the user's browser 111. When the user resubmits the service request by clicking the Login button, both the login information and the contextual information in hidden format are sent to the Web server by the Web browser. Then, the authenticator 123 authenticates the user if the login information entered is verified. Otherwise, the authentication fails and Steps 202A-202C are repeated.

Step 203: The user's is authenticated.

Step 204. The user's service request is processed; his access to a resource is granted; and the Web content returned, using the original contextual information.

In the process described above, Step 202 through Step 202C may be repeated as many times as the user submits incorrect login information. Alternatively, Step 202 through Step 202C may be repeated until a predetermined number of attempts is reached, at which point the server refuses to respond further.

In a regular circumstance where a user's login information is verified, the user only sees the pages in Step 201 and Step 204, and he is not required to re-enter the login information. While in an occurrence where the user's session was dropped by the Web server 121, an intermediate login page is provided for the Web client to reenter the user's login information (Step 202B). Upon entering correct login information, the user is able to see the Web content 122 in Step 204 just as what he sees in a regular circumstance. In this process, the user's workflow is resumed and the interrupted session is restored without losing of data.

In general, the embodiments of the invention are automated tools that can be used by anyone desiring to continue interrupted sessions in a stateless network, whether such sessions are business-related, recreational, informational or otherwise.

Implementation of the Authenticator in Active Server Pages

The active server pages code that implements an authenticator 123 is given in Table 1 Section 1 through Section 3. TABLE 1

TABLE 1
Source Code Section 1. On top of every Active Service Page (ASP) which require security, the following code
ValidLogin), and either allow application flow
continue (Call Main) or deny access and show the login page (Call Access Denied)
If ValidLogin( ) Then

Call Main( )

Else

Call AccessDenied( )

End If
Sub Main

Response.Write Header( )
Response.Write Body( )
Response.Write Footer( )

End Sub
Source Code Section 2. ″ValidLogin( )″ is used to check if the current user is already logged in or call to
authenticate the user.
Function ValidLogin ′As Boolean
Dim bValid ′As Boolean
Dim Login ′As Login

′ If we don't have a Login ID in the session already,
′ check to see if new values just been submitted
If Session(″_login_id″) = ″″ Then

Session(″_login_id″) = Request.Form(″_login_id″)
Session(″_authentication″) = Request.Form(″_authentication ″)

End If
′ If we have a Login ID, call to authenticate current ID and
′ password values against the database (using a Login object)
If Session(″_login_id″) <> ″″ Then

Set Login = MainLogin( )
Bvalid = Login.CheckLogin(Session(″_login_id,

Session(″_authentication″) )

′ If authentication failed, clear current values
′ so that next time around new valus will be read
′ from the submitted request
If Not bValid Then

Session(″_login_id″) = ″″
Session(″_authentication″) = ″″

End If

End If
ValidLogin = bValid

End Function
Source Code Section 3. ″AccessDenied( )″ is called when user authentication failed for missing or wrong
login values. Show the login screen and remember all submitted values as well as the current requested
URL. Current URL will be used to resubmit (sNextURL) when the login ID and password are provided for
validation.
Sub AccessDenied

′ Get the current Login object upfront. First check if Access
′ was denied due to the Login user not being enabled yet and
′ redirect to registration.
If MainLogin.LoginErrorNumber = 4 Then

Response.Redirect(″Register.asp″)

```
End If
Response.Write Header( )
′ Build the (next) URL to return after user authentication.
Dim sNextURL ′As String
SNextURL = Request.ServerVariables(″SCRIPT_NAME″) & ″?″ & _{—}
      Request.ServerVariables(″QUERY_STRING″)
′ Build the html form to post back to the same URL requested.
Response.Write ″<form name=″″LoginForm″″ method=″″post″″ ″&_{—}
      ″action=″″″ & sNextURL & ″″″>″
′ Save all currently submitted data to be resubmitted when returned to login.
′ Walk the Collection of form elements and get all elemetns that does not named
′ with ″_″ (private) in front.
Dim i, j ′As Integer
For Each i in Request.Form
```

If Left(I,1) <> ″_″ Then

For j = 1 to Request.Form(I).count

Response.Write ″<input type=″″hidden″″ name=″″ & I &_{—}
″″″ value=″″″ & Server.HTMLEncode(Request.Form(I) (j) ) & ″″″>″

Next

End If
Next

Response.Write ″<p align=″″center″″>For authentication and privacy, we require that you

login periodically.<br>Please enter you login ID and password.</p>″

′ Paint the login screen.
Response.Write ″<input type=″″text″″ name=″″_login_id″″ value=″″″ & _{—}
MainLogin.LoginID & ″″″>″
Response.Write ″input type=″″password″″ name=″″_authentication″″>″
′ Check for any login errors to report or act on.
Select Case MainLogin.LoginErrorNumber

Case 0 ′No Error
Case 1,2,3 ′IDNotFound, WrongAuthentication, NoApplication

Response.Write ″<span>″ & MainLogin.LoginErrorText & ″</span>

End Select
Response.Write ″<p><input type=″″submit″″ value=″″login″″></p>″
Response.Write ″</form>″
Response.Write Footer( )

End Sub

Table 1 Section 1 illustrates a typical structure wherein an authenticator is used in active server pages.

Step 202: The authenticator first calls a subroutine ValidLogin( ) to verify a user's login information. Depending on whether authentication success or authentication failure is returned, the Web server 121 continues with Step 203 or Step 202A.

Steps 203-204: If ValidLogin( ) returns authentication success, in other words, if the user's login information is verified, then the Web server 121 continues to serve the user's request and return the requested Web content 122 to the user.

Steps 202A-202C: If ValidLogin( ) returns authentication failure, in other words, if the user's login information fails to match the ID information stored in the database, then the authenticator calls a subroutine AccessDenied( ) to deny access and show a login page.

Table 1 Section 2 is the source code for subroutine ValidLogin( ) corresponding to Step 202, which is used to check whether a current user has already logged in or call to authenticate the user, comprising the sub-steps of:

(1): Checking whether a session already exists for the user. If there is no existing session found, a new session is created by extracting the login information from the service request submitted by the user. If there is an existing session found, the original login information stored in the session is retrieved.

(2): Verifying the user's login information. If the login information is successfully retrieved and verified, authentication success is returned, and thus the user's request is proceeded and the corresponding Web content is displayed on the user's screen (Steps 203-204). If the login information is not found in the submitted request, or if the login information is incorrect, or if the user's session has expired, authentication failure is returned and the subroutine AccessDenied( ) is called, a login page is sent to the browser (Steps 202A-202B).

Table 1 Section 3 is the source code for subroutine AccessDenied( ), which is used when user authentication failed for missing or wrong login values, comprising the following steps:

Registration Check: The authenticator first checks whether the reason for authentication failure is that the user has been disabled or deactivated or blocked off. If so, the login page in Step 202B is not shown on the user's screen. Instead, the user is directed to a new user registration page so that he may register as a new user. This step is optional and it is not included in FIG. 2.

Step 202B: This step comprises the sub-steps of:

(1): Creating a login page that contains a login form, wherein the original request URL is retrieved and set to next URL for the login page;

(2): Formatting the original contextual information into hidden fields in the login page;

(3): Sending the login page along with contextual information in hidden format to user's Web browser, from which the user is able to see the login page.

A Real Life Example Using the Invention

An example is given below to illustrate how the invention described above is used to restore an interrupted virtual session by a medical relationship management application service provider Web site.

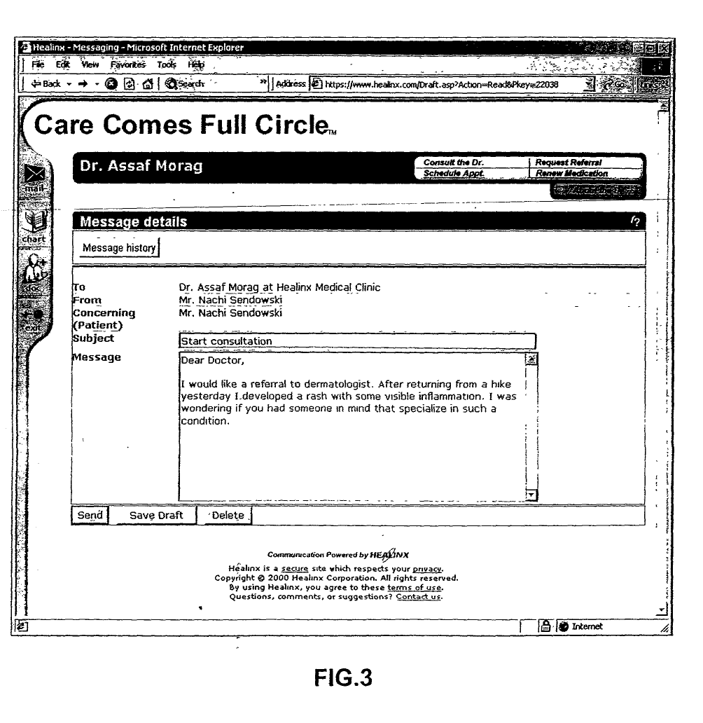

Mr. Nachi Sendowski has registered in the medical relationship management application service provider's Web site as a patient user. He developed a rash with some visible inflammation after returning from a hike. Now he logs into the application service provider's Web site from his PC at home and prepares to send a message to his doctor about his situation. FIG. 3 shows the page that is displaying in his browser after he types part of the message.

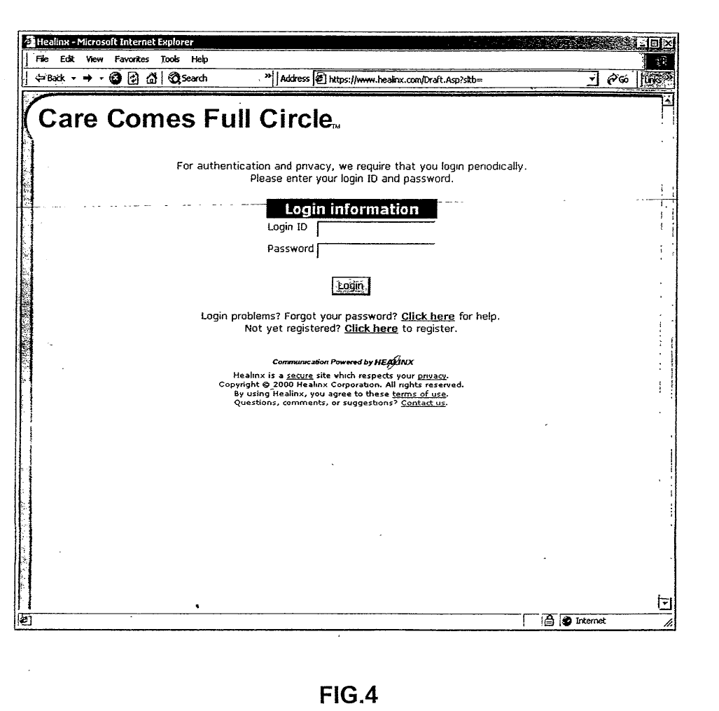

Before he finishes his message, the phone rings. After he talked on the phone for half hour, he comes back to his computer. When he finishes the message, he clicked the Send button. The authenticator in the Web server does not authenticate him because he has been timed out. Rather, it records all the user input, i.e. the contextual information included in his original request as hidden fields, and sends the hidden information along with a login page to his screen. FIG. 4 shows the login page, wherein the contextual information is invisible because it is hidden in HTML. The HTML source code for the login page is shown in Table 2. All user inputs are recorded as hidden fields that have names of the corresponding fields when the user first clicks the Send button.

TABLE 2
HTML Source Code for the Login Screen

<!DOCTYPE HTML PUBLIC <!doctype html public “-//w3c//dtd html 4.0
transitional//en”>
<html>
<head>

<meta http-equiv=“Content-Type” content=“text/html; charset=iso-8859-1”>
<meta name=“Description” content=“Login”>
<meta name=“GENERATOR” content=“Mozilla/4.5 [en] (WinNT; U) [Netscape]”>
<title>Healinx</title>
<link rel=“stylesheet” type=“text/css” href=“css/Styles.css”>
<script language=“JavaScript”><!−−
function ShowHelp(url) { var hWnd =
window.open(url, “HelpWindow”, “width=613,height=400, resizable=yes,scrollbars=yes
”); if (window.focus) hWnd.window.focus( ); }
// −−></script>
</head>
<body bgcolor=“#FFFFFF” background=“background.gif” topmargin=“0”
leftmargin=“0” marginwidth=“0” marginheight=“0”>
&nbsp;
<table BORDER=0 CELLSPACING=0 CELLPADDING=0 WIDTH=“100%” >
<tr>
<td HEIGHT=“62”><a href=“default.asp” target=“_top”><img SRC=“healinx_logo.gif”
ALT=“Return to the Healinx home page” BORDER=0 / height=62 width=419></a></td>
<td WIDTH=“100%”><img SRC=“toptile.gif” ALT=“” BORDER=0 / height=62
width=100%></td>
</tr>
</table>
<table BORDER=0 CELLSPACING=0 CELLPADDING=0 WIDTH=“100%” >
<tr>
<td VALIGN=TOP WIDTH=“48”></td>
<td VALIGN=TOP WIDTH=“25”><img SRC=“pixel.gif” / height=1 width=25></td>
<td VALIGN=TOP WIDTH=“100%”>
<table BORDER=0 >
<caption><tbody>
<br></tbody></caption>
<tr>
<td HEIGHT=“2”></td>
</tr>
</table>
<form name=“LoginForm” method=“post” action=“/Draft.Asp>?sltb=“>
<input type=“hidden” name=“TableName” value=“Message”>
<input type=“hidden” name=“FormName” value=“EditPatientMessage”>
<input type=“hidden” name=“OriginalTSLastModified” value=“0x000000000008DE26”>
<input type=“hidden” name=“OriginalRecipient” value=“18”>
<input type=“hidden” name=“OriginalSender” value=“23”>
<input type=“hidden” name=“DisplayPatientRO” value=“Mr. Nachi Sendowski”>
<input type=“hidden” name=“OriginalRoot_Message” value=“ ”>
<input type=“hidden” name=“OriginalSubject” value=“Start consultation”>
<input type=“hidden” name=“OriginalMessage_Text” value=“ ”>
<input type=“hidden” name=“PKey” value=“22038”>
<input type=“hidden” name=“TSLastModified” value=“0x000000000008DE26”>
<input type=“hidden” name=“DisplayRecipient” value=“Dr. Assaf Morag at Healinx
Medical Clinic”>
<input type=“hidden” name=“Action” value=“Send”>
<input type=“hidden” name=“Recipient” value=“Dr. Assaf Morag at Healinx
Medical Clinic ”>
<input type=“hidden” name=“PatientRO” value=“Mr. Nachi Sendowski”>
<input type=“hidden” name=“TableName” value=“Message”>
<input type=“hidden” name=“Subject” value=“Start consultation”>
<input type=“hidden” name=“CurrentRecipient” value=“18”>
<input type=“hidden” name=“Sender” value=“Mr. Nachi Sendowski”>
<input type=“hidden” name=“Root_message” value=“ ”>
<input type=“hidden” name=“DisplaySender” value=“Mr. Nachi Sendowski”>
<input type=“hidden” name=“CurrentSender” value=“23”>
<input type=“hidden” name=“CurrentPatientRO” value=“5”>
<input type=“hidden” name=“Message_Text” value=“Dear Doctor,
I would like a referral to dermatologist. After returning from a hike
yesterday I developed a rash with some visible inflammation. I was
wondering if you had someone in mind that specialize in such a
condition.”>
<center>
<p>For authentication and privacy, we require that you login periodically.
<br>Please enter your login ID and password.</center>
<br>&nbsp;
<center><table CELLSPACING=0 CELLPADDING=2 class=“FormTable” >
<tr BGCOLOR=“#339900” class=“FormTitle”>
<th COLSPAN=“2” class=“FTTD”><font color=“#FFFFFF”>Login
information</font></th>
</tr>
<tr class=“EditFieldRow”>
<td class=“EditFieldLeftCol”>Login ID</td>
<td class=“EditFieldRightCol”><input class=“TextControl” type=“text”
name=“_login_id” Value=“”></td>
</tr>
<tr class=“EditFieldRow”>
<td class=“EditFieldLeftCol”>Password</td>
<td class=“EditFieldRightCol”><input class=“PasswordControl” type=“password”
name=“_authentication”></td>
</tr>
</table></center>
<center>
<p><input type=“submit” value=“Login”></center>
</form>
<center>
<p><input type=“submit” value=“Login”></center>
</form>
<center>
<p>Login problems? Forgot your password? <b><a
href=“Help.asp?Topic=Login&SubTopic=Password”>Click
here</a></b> for help.
<br>Not yet registered? <b><a href=“register.asp?Status=new”>Click here</a></b>
to register.</center>
<script language=“JavaScript”><!−−
function OnLoadHandler( ) {document.LoginForm._login_id.focus( );} window.onload =
OnLoadHandler; //−−></script>
</td>
</tr>
</table>
<center>
<p><a href=“/default.asp”><img SRC=“powered_by_healinx.gif” ALT=“Go to the
Healinx home page” BORDER=0 / height=29 width=222></a>
<br><font face=“Verdana, Arial, Helvetica, sans-serif”><font size=−2>Healinx
is a <a href=“Javascript:ShowHelp(‘html/Privacy-security.html#security’)”
title=“View Healinx's security policy”>secure</a>

site which respects your <a
href=“Javascript:ShowHelp(‘html/Privacy
security.html#privacy’)” title=“View Healinx's privacy
policy”>privacy</a>.</font></font>
<br><font face=“Verdana, Arial, Helvetica, sans-serif”><font size=−2>Copyright
&copy; 1999-2000 Healinx Corporation. All rights reserved.</font></font>
<br><font face=“Verdana, Arial, Helvetica, sans-serif”><font size=−2>By
using Healinx, you agree to these <a href=“help.asp?Topic=Terms” title=“View
Healinx's terms of use”>terms
of use</a>.</font></font>
<br><font face=”Verdana, Arial, Helvetica, sans-serif”><font size=−2>Questions,
comments, or suggestions? <a
href=“Help.asp?Topic=Contact&DevValues=Page+values+collected+on+10%2F22%2F00+1%
3A30%3A57+AM%0D%0AScript%3D%2Fwelcome%2Easp%0D%0ALogin%3D%0D%0AQueryString%3A%0
D%0AFormItems%3A%0D%0A” title=“Contact someone at Healinx”>Contact
us</a>.</font></font></center>
</body>
</html>

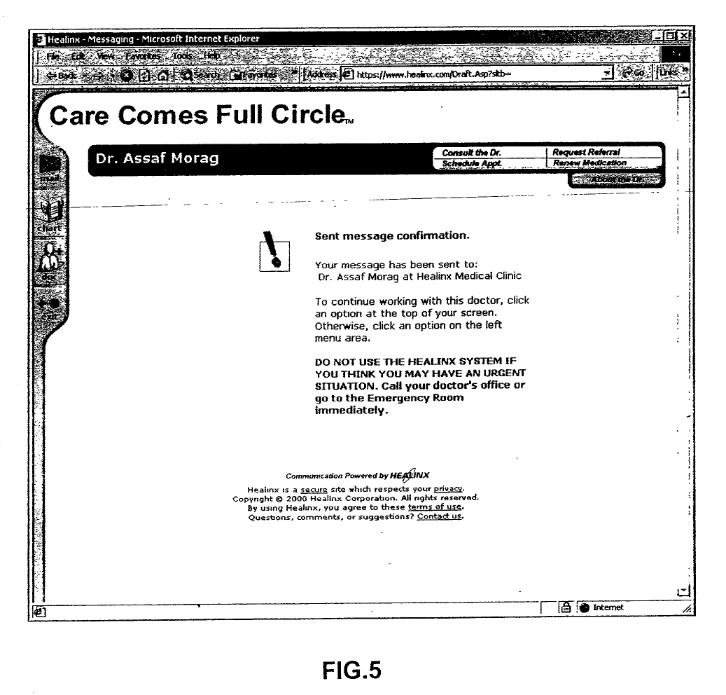

The patient then fills in the correct login information and clicks the Login button. The original contextual information in hidden format is sent to the medical service provider Web site along with the login information. The authenticator successfully verifies the login information and passes the original contextual information to the originally requested action, which returns an HTML page containing confirmation of the message delivery. This HTML page is displayed on the patient's browser as shown in FIG. 5.

In this example, the patient's workflow of sending a message to his doctor was interrupted for timing out. For adoption of the invention, the patient now is able to resume his page flow without losing any data upon a successful login.

Although the invention is described herein with reference to the preferred embodiment, one skilled in the art will readily appreciate that other applications may be substituted for those set forth herein without departing from the spirit and scope of the present invention.

Accordingly, the invention should only be limited by the claims included below.

1. A process, embodied in an interactive message communication system via a stateless network, for resuming user authentication and restoration of interrupted virtual sessions without loss of data or disruption of workflow, comprising the steps of:
receiving a service request from a user who has logged into a service provider Website application via a browser running on a Web client device,
wherein said service provider Website application runs on a Web server coupled to a Web content, a database, and an authenticator;
authenticating said user, wherein said Web server returns a login page to said browser if authentication fails for any reason; and
upon a successful authentication, proceeding said service request submitted by said user.

2. A process as set forth in claim 1, wherein said step of receiving a service
request further comprises the steps of:
receiving URL and all contextual information associated with said service request, wherein said contextual information is the information that identifies where said user is and where he is going to during a communication session.

3. A process as set forth in claim 1, wherein said step of authenticating said user further comprises the sub-steps of:
checking whether a session already exists for said user,
wherein if there is no existing session found, a new session is created by extracting said user's login information from said service request submitted by said user,
wherein if there is an existing session found, said authenticator retrieves said user's original login information stored in said session; and
verifying said user's login information against said database,
wherein if said login information is successfully verified, authentication success is returned, and thus said user's service request is proceeded and the corresponding Web content is displayed on said user's screen,
wherein if said login information is not verified for any reason, authentication failure will be returned and said login page will be sent to said browser.

4. A process as set forth in claim 3, further comprising the steps of:
if said login information is not verified for any reason, creating said login page that contains a login form, wherein said user's original service request URL is retrieved and set to next URL for said login page;
formatting said user's original contextual information into hidden fields in said login page; and
sending said login page along with said contextual information in hidden format to said user's Web browser, from which said user is able to see said login page, re-enter his login information, and initiate a new login for authentication.

5. A process as set forth in claim 4, wherein said authenticator first conducts a registration check, wherein if said user has been disabled or deactivated or blocked off, said user is directed to a new user registration page so that said user may register as a new user.

6. A process as set forth in claim 4, wherein said steps from authentication failure to resubmission of login information may be repeated as many times as said user enters incorrect login information.

7. A process as set forth in claim 4, wherein said steps from authentication failure to resubmission of login information may be repeated until a predetermined number of attempts for login is reached, at which point said server refuses to respond further.

8. A process as set forth in claim 1, wherein said step of proceeding said service request further comprises any of the steps of:
sending a Web content selected by said user to said browser in an uninterrupted session; and
returning the Web content to which said user accessed immediately before interruption or timing-out in an interrupted session.

9. A process as set forth in claim 1, wherein said user is a service provider such as a physician or a customer such as a patient.

10. A process as set forth in claim 1, wherein said browser is any suitable browser software.

11. A process as set forth in claim 1, wherein said Web client device is a personal computer or a personal digital assistant or any other kind of Web-enabled devices capable of sending and receiving information via the Internet.

12. A process as set forth in claim 1, wherein said Web content entails all the services and data that said service provider Website application provides to its clients.

13. A method for restoration of an interrupted virtual session in a stateless network comprising the steps of:
authenticating said user when said Web server receives said user's service request;
if authentication succeeds, restoring said session by returning a Web content to said browser, wherein said Web content is the Web content to which said user accessed immediately before said session was interrupted; and
if authentication fails for any reason, sending a login page, together with said contextual information associated with said service request, back to said browser, wherein said user is required to reenter his login information and submit said login information to said Web server for authentication.

14. A method as set forth in claim 13, wherein said authenticator calls a subroutine that leads to either an authentication failure or an authentication success.

15. A method as set forth in claim 14, wherein said subroutine comprises the sub-steps of:
checking whether a session already exists for said user,
wherein if there is no existing session found, said Web server creates a new session by extracting said user's login information from said service request submitted by said user;
wherein if there is an existing session found, said Web server retrieves said user's login information stored in said session; and
verifying said user's login information against said database that contains said user's correct login information,
wherein if said user's login information matches with said user's correct login information stored in said database, authentication success is returned;
wherein if said user's login information does not match with said user's correct login information stored in said database, authentication failure is returned and a second subroutine is called.

16. A method as set forth in claim 15, wherein said second subroutine comprises the sub-steps of:
creating a login page that contains a login form, wherein said user's original request URL is retrieved and set to next URL for the login page;
formatting said original contextual information into hidden fields in said login page; and
sending said login page, together with said contextual information in hidden format, to said browser from which said user can see said login page.

17. A method as set forth in claim 15, wherein said second subroutine further comprises the steps of:
checking if said user has been disabled from said Web server,
wherein if said user has been disabled from said Web server for any reason, then said login page is not sent to said browser, instead, a new user registration page is sent to said browser in order that said user may register as a new user;
wherein ifsaid user is currently enabled but authentication fails for any reason, then said login page is sent to said browser.

18. A computer network comprising:
a service provider Website, wherein said service provider Website comprises a Web server, a Web content, and a database, wherein said Web content is coupled to an authenticator;
a number of service provider Web clients, wherein said service provider Web client comprises a browser installed on a service provider Web client device;
a number of service user clients, wherein said service user Web client comprises a browser installed on a service user Web client device;
an Internet via which said Web server, said service provider clients, and said service user Web clients communicate; and further comprising means for:
receiving a service request from a user who has logged into a service provider Website application via a browser running on a Web client device,
wherein said service provider Website application runs on a Web server coupled to a Web content, a database, and an authenticator;
authenticating said user, wherein said Web server returns a login page to said browser if authentication fails for any reason; and
upon a successful authentication, proceeding said service request submitted by said user.

19. A computer network as set forth in claim 18, wherein said service provider Web site is a medical service provider Web site, wherein said service provider is a medical doctor or a doctor extender which may comprise any of a registered nurse, medical assistant or technician, pharmacy, medical device manufacturer or retailer, or any other person or entity which provides services to or on behalf of medical professionals, wherein said service user Web client is a patient for medical service.

20. A computer network as set forth in claim 18, wherein said browser may be any suitable browser software.

21. A computer network as set forth in claim 18, wherein said service provider Web client device and said service user Web client device may be a personal computer or a personal digital assistant or any other kind of Web-enabled devices capable of sending and receiving information via the Internet.

22. A computer network as set forth in claim 18, wherein said Web content entails all the services and data that said service provider Website provides to its clients.
